(19) United States
(12) Patent Application Publication
(10) Pub. No.: US 2010/0180229 A1
(43) Pub. Date: Jul. 15, 2010

(54) Method for menu performance using shortcut key in potable terminal and apparatus thereof

(75) Inventor: Joo Ha Lee, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/655,976

(22) Filed: Jan. 11, 2010

(30) Foreign Application Priority Data
Jan. 12, 2009 (KR) 10-2009-0002170

(51) Int. Cl. G06F 13/38; G06F 3/048

(52) U.S. Cl. 715/808; 710/67; 715/841

(57) ABSTRACT

A portable terminal with a display includes an apparatus for executing a menu using a shortcut key. The portable terminal can sense an input of a shortcut key and apply a setting value of the shortcut key if the input of the shortcut key is sensed.

### CROSS-REFERENCE TO RELATED APPLICATION(S) AND CLAIM OF PRIORITY

The present application is related to and claims the benefit under 35 U S.C. §119 a of a Korean patent application filed in the Korean Intellectual Property Office on Jan. 12, 2009 and assigned Serial No. 10-2009-0002170, and the entire disclosure of which is hereby incorporated by reference.

### TECHNICAL FIELD OF THE INVENTION

The present invention relates to a method and apparatus for executing a menu of a portable terminal, more particularly, to a method and apparatus for executing a menu using a shortcut key of a portable terminal, which designates a specific key of the portable terminal and applies a setting value allocated to the shortcut key by a user according to the shortcut key input.

### BACKGROUND OF THE INVENTION

People at different places can easily and quickly send information to each other using a portable terminal. Such a portable terminal has been rapidly developed as a mobile communication terminal with improved portability thanks to the development of communication technologies. Today, such a mobile communication terminal is so widely used that it is now recognized as one of necessaries of people.

Generally, a portable terminal provides various menus through a user interface (UI), and executes a menu selected by a user among the various menus. At this time, in order to use a menu provided by a portable terminal, the user searches a corresponding menu and selects one of the found menus to enter the menu. Here, each menu includes several sub-items. The user chooses a specific item among the sub-items of the menu. Thus, the user may feel that the menu execution process is complicated. Also, according to the existing menu execution method, if a user intends to select another menu, the user is required to repeat the process of searching a menu and selecting a sub-menu item.

### SUMMARY OF THE INVENTION

To address the above-discussed deficiencies of the prior art, it is a primary object to provide a method and apparatus for executing a menu of a portable terminal, which can designate a specific key of the portable terminal as a shortcut key and can allocate a sub-item of a specific menu as a setting value to the shortcut key.

The present invention further provides a method and apparatus for executing a menu of a portable terminal, which can conveniently apply a setting value using a shortcut key set by a user.

The present invention further provides a method and apparatus for executing a menu of a portable terminal, which can sequentially apply a setting value allocated to a shortcut key through repeated inputs of the portable terminal.

In accordance with an aspect of the present invention, a method for executing a menu using a shortcut key of a portable terminal includes sensing an input of a shortcut key and applying a setting value of the shortcut key if the input of the shortcut key is sensed.

In accordance with another aspect of the present invention, an apparatus for executing a menu of a portable terminal includes an input unit configured to input a shortcut key and a controller configured to apply a setting value of the shortcut key if an input of the shortcut key is sensed.

In accordance with another aspect of the present invention, A mobile terminal, the mobile terminal includes a display configured to display a menu, an input unit configured to receive an input for a shortcut key, and a controller configured to apply a setting value of the shortcut key, if an input of the shortcut key is sensed.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a portable terminal according to an exemplary embodiment of the present invention;

FIG. 2 illustrates the overall operation of a portable terminal according to an exemplary embodiment of the present invention;

FIG. 3 illustrates a method of setting a shortcut key of a portable terminal according to an exemplary embodiment of the present invention;

FIGS. 4A through 4E illustrate a method of setting a shortcut key of a portable terminal according to an exemplary embodiment of the present invention;

FIG. 5 illustrates a method of setting a shortcut key using combination mode of a portable terminal according to an exemplary embodiment of the present invention;

FIGS. 6A and 6B illustrate a method of setting a shortcut key using combination mode of a portable terminal according to an exemplary embodiment of the present invention;

FIG. 7 illustrates a method of executing a menu using a shortcut key of a portable terminal according to an exemplary embodiment of the present invention; and

FIGS. 8A through 8E illustrate a method of executing a menu using a shortcut key of a portable terminal according to an exemplary embodiment of the present invention.

### DETAILED DESCRIPTION OF THE INVENTION

FIGS. 1 through 8E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. Detailed descriptions of well-known functions and structures incorporated herein may be omitted to avoid obscuring the subject matter of the present invention.

In embodiments of the present invention, a “menu” refers to a menu that can be set by a shortcut key. That is, the menu may include various menus such as theme, language, font, font color, text location, font size and alarm. Here, each menu includes various sub-items. The sub-items can be allocated to the shortcut key as the set value by the user's selection.

In the embodiments of the present invention, the “set value” refers to an item which is selected by a user and is allocated to a shortcut key among sub-items included in a specific menu of a portable terminal. Here, the several shortcut keys can be allocated to the shortcut key and can be applied according to the input of the shortcut key.

In the embodiments of the present invention, the “shortcut key” can allocate at least one of the items selected by the user among the items of a specific menu as a set value. Here, if a specific key is inputted by the user for more than given time, it can be recognized as a shortcut key input signal. Also, the shortcut key can be a specific number key or one of various types of keys (e.g., a function key such as a volume key and a camera key) included in the key pad of a portable terminal.

In the embodiments of the present invention, the shortcut key is explained to use one specific key, but the number of shortcut keys is not limited to this. That is, the shortcut key can consist of a plurality of specific keys. Here, if a plurality of shortcut keys is used, each shortcut key is allocated different setting values of each different menu.

FIG. 1 illustrates a configuration of a portable terminal according to an exemplary embodiment of the present invention.

Referring to FIG. 1, the portable terminal of the present invention includes a controller 100, an input unit 110, a display unit 120, a storage unit 130 and a wireless communication unit 140.

The input unit 110 receives information such as number information and character information, and transmits a signal inputted in connection with setting of various functions and the function control of a portable terminal to the controller 100. Additionally, the input unit 110 can generate an input signal according to the user's behavior, and can include at least one of a keypad and a touch pad. Here, the input unit 110 can perform both input and display functions while being configured in the form of a touch panel (or a touch screen) along with the display unit. Particularly, the input unit 110 includes a shortcut key. The shortcut key can be mapped to a specific key of a keypad in a shortcut key designation mode. Also, the input unit 110 can transmit a selection signal for a specific menu to the controller 100 in shortcut key setting mode, and transmit a selection signal for an item allocated as a setting value of the shortcut key among sub-items of the specific menu to the controller 100. Also, the input unit 110 transmits the shortcut key signal inputted by the user to the controller 100.

The display unit 120 displays information that is related to a series of operation states and results generated during performing a function in a portable terminal. Also, the display unit 120 can display menus of the portable terminal and user data inputted by the user on the screen. Here, the display unit 120 can comprise an LCD (liquid crystal display). Particularly, the display unit 120 according to an exemplary embodiment of the present invention displays a screen for shortcut key designation mode and shortcut key setting mode. Also, if a shortcut key setting mode is executed by the user's input, the display unit 120 highlights a specific menu of the given shortcut key. Also, the display unit 120 can present a list of menus that can be combined with a specific menu first selected in combination mode. Also, if a shortcut key signal inputted from the user is transmitted, the display unit 120 displays a screen where a setting value allocated to the shortcut key is applied. Also, the display unit 120 displays a message for the changed setting value on the screen in the form of a pop-up window.

The storage unit 130 stores application programs that are necessary for operating functions according to embodiments of the present invention. Such a storage unit 130 includes a program area and a data area.

The program area may include an operating system (OS) that boots a portable terminal, a program that maps a specific key selected by the user to a shortcut key in the shortcut key designation mode, a program that allocates items selected among sub-items of a specific menu as a setting value of a shortcut key in the shortcut key setting mode, and a program that sequentially applies setting values according to the shortcut key input.

Also, the data area may include data generated by execution of an application of a portable terminal and all forms of data that can be received from the outside and can be stored. Particularly, in the embodiments of the present invention, the data area can store data generated by the shortcut key input of the user and setting values allocated to the shortcut key. Also, the data area can store items of a specific menu that are selected by the user in combination mode. Also, the data area according to the present invention can combine items that can be combined in combination unit and can be stored as shown in Tables 1, 2 and 3.

TABLE 1

| | Gulim | Batang | Gothic | Gungseo |
|---|---|---|---|---|
| Korean | Korean + Gulim | Korean + Batang | Korean + Gothic | Korean + Gungseo |
| English | English + Gulim | English + Batang | English + Gothic | English + Gungseo |
| Japanese | Japanese + Gulim | Japanese + Batang | Japanese + Gothic | Japanese + Gungseo |
| Chinese | Chinese + Gulim | Chinese + Batang | Chinese + Gothic | Chinese + Gungseo |

Table 1 shows items that can be generated through combination of language and font in combination mode according to an exemplary embodiment of the present invention.

Referring to Table 1, the controller 100 presents a list of menus that can be combined with languages according to the execution signal of combination mode after a language is selected, and executes combination with the selected font. Here, the controller 100 can store the combination of sub-items of a language which are Korean, English, Japanese and Chinese and sub-items of the font which are Gulim, Batang, Gothic and Gungseo.

TABLE 2

| | 9 pt | 10 pt | 11 pt | 12 pt |
|---|---|---|---|---|
| Korean | Korean + 9 pt | Korean + 10 pt | Korean + 11 pt | Korean + 12 pt |
| English | English + 9 pt | English + 10 pt | English + 11 pt | English + 12 pt |
| Japanese | Japanese + 9 pt | Japanese + 10 pt | Japanese + 11 pt | Japanese + 12 pt |
| Chinese | Chinese + 9 pt | Chinese + 10 pt | Chinese + 11 pt | Chinese + 12 pt |

Table 2 shows items which can be generated through combination a language and a font size in combination mode according to an exemplary embodiment of the present invention.

Referring to Table 2, the controller 100 presents a list of menus that can be combined with languages according to combination mode execution signal inputted after a language is selected, and executes combination with the selected font size. Here, the controller 100 can store combination of sub-items of languages, which are Korean, English, Japanese and Chinese and sub-items of font size, which are 9pt, 10pt, 11pt and 12pt.

TABLE 3

| | Black | Blue | Red |
|---|---|---|---|
| Korean | Korean + Black | Korean + Blue | Korean + Red |
| English | English + Black | English + Blue | English + Red |
| Japanese | Japanese + Black | Japanese + Blue | Japanese + Red |
| Chinese | Chinese + Black | Chinese + Blue | Chinese + Red |

Table 3 presents items that can be generated through combination of languages and font colors in combination mode according to an exemplary embodiment of the present invention.

Referring to Table 3, the controller 100 presents a list of menus that can be combined with a language according to combination mode execution signal after a language is selected. Here, the controller 100 store combination of sub-items of languages which are Korean, English, Japanese and Chinese and sub-items of font colors, which are Black, Blue and Red.

The wireless communication unit 140 controls communication that forms a communication channel with a base station for phone calls or transmission and reception of messages between portable terminals. Also, the wireless communication unit 140 may include an RF transmission unit that up-converts and amplifies the frequency of transmitted signals, and an RF reception unit which low-noise amplifies received signals and down-converts the frequency.

The controller 100 controls the overall operation for each element of a portable terminal and controls the signal flow between blocks within the portable terminal. Particularly, if a shortcut key setting mode is executed, the controller 100 can display a shortcut key designation screen. Then, the controller 100 can map a specific key selected by the user in shortcut key designation mode to a shortcut key. Here, in case a specific key mapped to a shortcut key is a number key, the controller 100 determines whether a speed dial function is set in the number key, and if the speed dial function has been set, it is possible to set to release the speed dial function according to the user's request.

The controller 100 can display a shortcut key setting menu list on the screen. Here, the controller 100 highlights a given menu as a shortcut key. The controller 100 can sense input signals for a specific menu selected by the user, and display sub-items of the menu on the screen. Then, the controller 100 can sense input signals of selected sub-items among sub-items of a specific menu. If the sub-items are selected, the controller 100 can allocate the sub-items as the setting value of a shortcut key. Here, in case a plurality of sub-items are selected, the controller 100 can set priorities of the selected multiple sub-items. The controller 100 can set priorities according to the order selected by the user or can make the user set priorities by outputting the screen for setting priorities.

The controller 100 can execute combination mode that combines a plurality of menu items and allocates the combinations to the setting value of the shortcut key. At this time, if combination mode is executed, the controller 100 can store sub-items of a selected menu and present a list of menus that can be combined with the menu on the screen. Thereafter, the controller 100 can present a list of combined items of given sub-items and sub-items of menus selected by the user on the screen. Here, the controller 100 can allocate selected items among combined items as the setting value of a shortcut key.

If a shortcut key signal, inputted for more than a given time, is sensed from the user, the controller 100 applies the setting value allocated to the shortcut key. At this time, the controller 100 can apply the setting value according to priorities set by the user or can apply the setting value corresponding to the next order of the setting value applied to the current menu. Here, the controller 100 can display the message according to the change of the setting value in the form of a pop-up window.

The controller 100 can apply the setting value corresponding to the next order of the currently applied setting value according to the shortcut key signal re-inputted from the user within a given time after inputting the shortcut key.

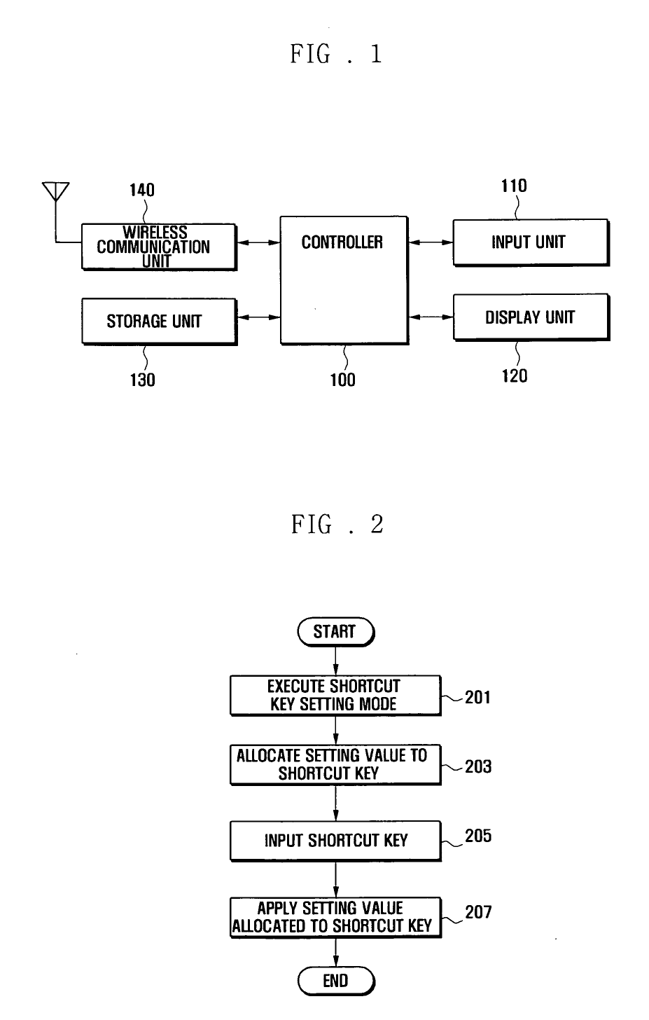

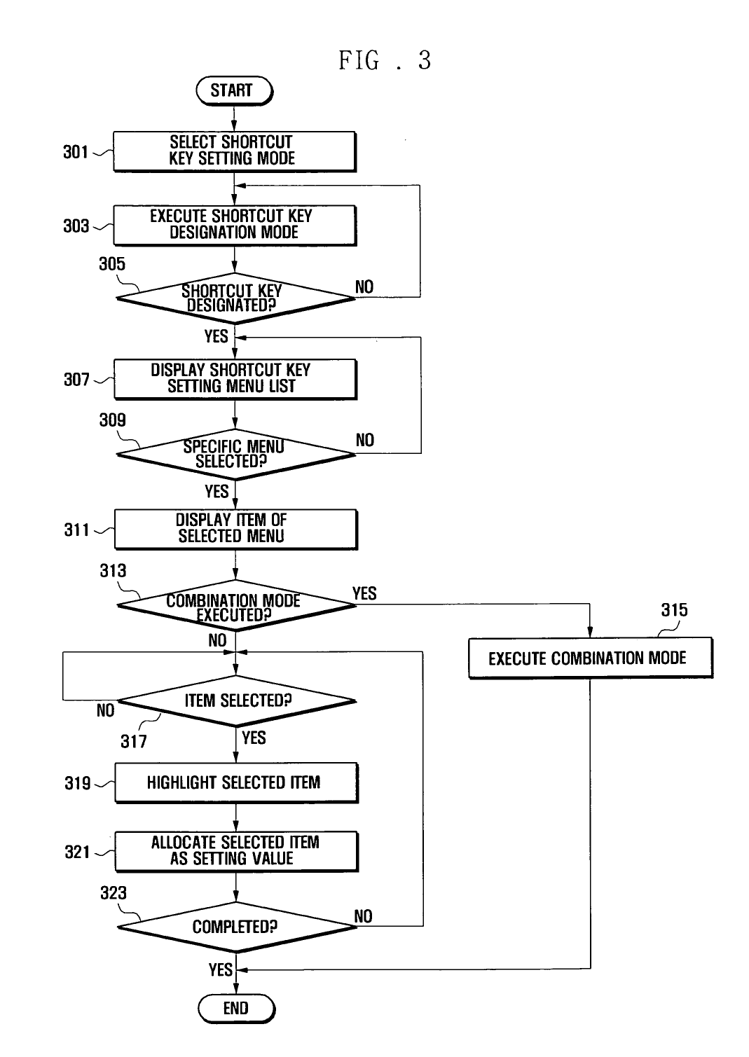

FIG. 2 illustrates the overall operation of a portable terminal.

Referring to FIG. 2, the controller 100 executes shortcut key setting mode (block 201). Here, the controller 100 can display the shortcut key designation mode screen and can map a specific key of the keypad selected in shortcut key designation mode to a shortcut key. Here, at least one of the items selected by the user among items of a specific menu can be allocated to a shortcut key as the setting value. Also, the shortcut key may be a specific number key included in the keypad of a portable terminal or can be one of various kinds of keys.

If a shortcut key is designated, the controller 100 can display the shortcut key setting menu list on the screen. Thereafter, the controller 100 can display sub-items corresponding to a specific menu according to the input signal of the specific menu selected by the user on the screen.

The controller 100 allocates at least one of the items selected among sub-items displayed on the screen as the setting value of a shortcut key (block 203). The controller 100 can combine items corresponding to a plurality of menus in combination mode and can allocate the combinations as the setting value of a shortcut key. At this time, the controller 100 can store sub-items of a specific menu first selected in combination mode, and can combine items selected in a menu that can be combined with the specific menu and allocate the combination as the setting value of the shortcut key.

If the shortcut key setting is completed, the controller 100 can sense the shortcut key signal (block 205). At this time, if a specific key designated as a shortcut key is inputted more than a given time, the controller 100 can consider the inputted key as the shortcut key signal.

If the shortcut key signal is sensed, the controller 100 applies the setting value allocated to the shortcut key (block 207). Also, the controller 100 can sequentially apply the setting value according to the re-inputted shortcut key signal. Here, the controller 100 can store a setting value of the highest priority according to the input of a shortcut key by the user. Thereafter, the controller 100 can control the display unit 120 to display a message according to the change of the setting value of the shortcut key in the form of a pop-up window.

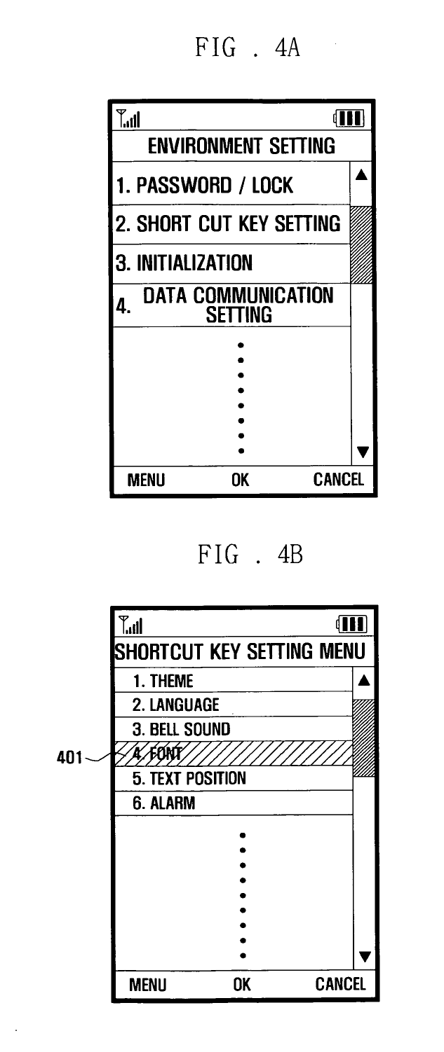

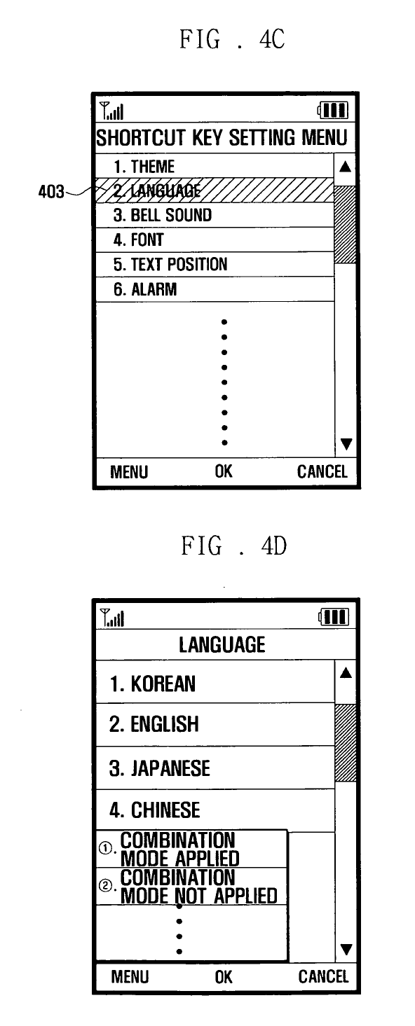

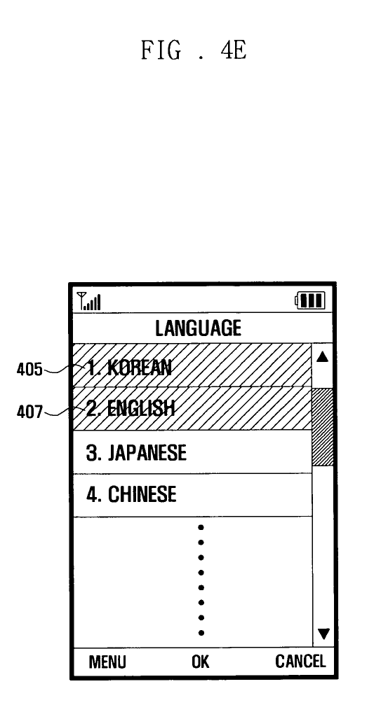

FIG. 3 illustrates a process of setting a shortcut key of a portable terminal according to an exemplary embodiment of the present invention, and FIGS. 4A through 4E illustrate a method of setting a shortcut key of a portable terminal according to an exemplary embodiment of the present invention.

Referring to FIGS. 3 to 4A, the controller 100 can sense a shortcut key setting mode selection signal (block 301). For example, as shown in FIG. 4A, if environment setting is executed, the controller 100 can present a list of environment setting mode on the screen. At this time, if the shortcut key setting mode is selected, the controller 100 executes the shortcut key designation mode (block 303). Here, the controller 100 can map a specific key selected by the user as a shortcut key.

If shortcut key designation mode is executed, the controller 100 determines whether a shortcut key has been designated (block 305). At this time, if a shortcut key has been designated, the controller 100 displays a shortcut setting menu list (block 307). At this time, the controller 100 can highlight a menu that has already been set in the current shortcut key. For example, as shown in FIG. 4B, the controller 100 can highlight a menu “4. Font” 401 that is currently set among the shortcut key setting menus. Also, the controller 100 can control to display a specific menu that has been already set as a shortcut key on the uppermost position of the shortcut key setting menu list. Further, if a shortcut key is not designated, the controller 100 returns to step 307 and continually executes shortcut key designation mode.

The controller 100 determines whether an input signal of a specific menu selected by the user among the shortcut key menu list is selected (block 309). For example, as illustrated in FIG. 4C, the controller 100 can sense the selection signal of “2. Language” 403 inputted by the user. Here, the controller 100 can highlight the selected “2. Language” 403.

If a specific menu is not selected, the controller 100 returns to step 307, and if a specific menu is selected, the controller 100 can display sub-items of the selected menu on the screen (block 311). Thereafter, the controller 100 can determine whether combination mode is executed (block 313). At this time, combination mode means combining each of the items corresponding to a plurality of menus and allocating the combinations as the setting value of a shortcut key. For example, as illustrated in FIG. 4D, the controller 100 can present the list of sub-items of “combination mode applied” and “combination mode not applied.”

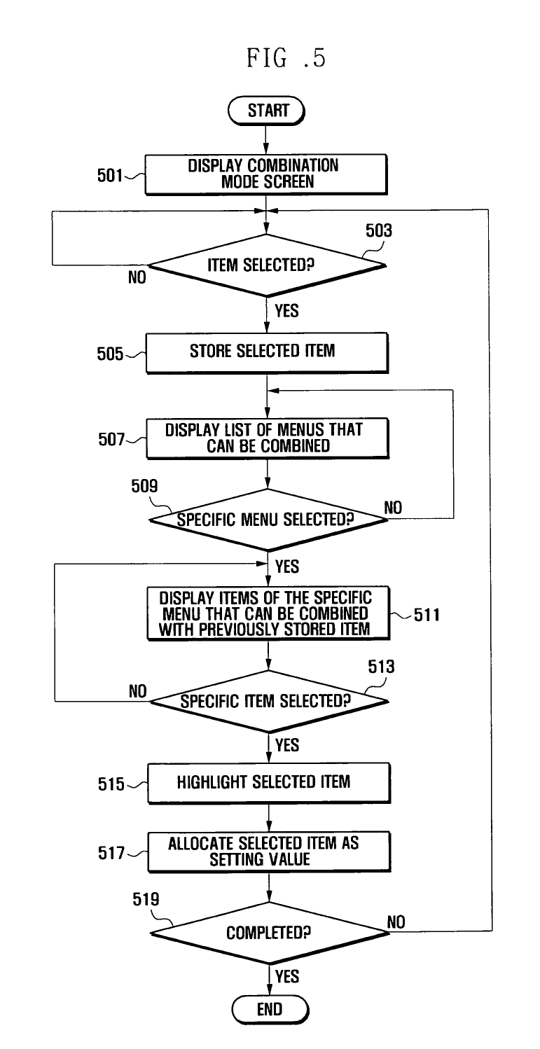

If combination mode is executed, the controller 100 can execute shortcut key setting mode according to the combination mode (block 315). Here, the combination mode will be explained later with reference to FIG. 5. Further, if combination mode is not executed, the controller 100 can determine whether at least one of the items is selected among sub-items of a specific menu (block 317). If at least one of the items among the sub-items of the specific menu is not selected, the controller 100 maintains step 317 and if at least one of the items is selected among sub-items of the specific menu, the controller 100 can move to step 319 and highlight the selected item. For example, as shown in FIG. 4E, the controller 100 can output sub-items included in a specific menu “language” such as “1. Korean”, “2. English”, “3. Japanese” and “4. Chinese.” Here, the controller 100 can sense signals for items selected by the user among sub-items. Then, if a signal that chooses “1. Korean”405 and “2. English” 407 is sensed, the selected sub-items can be highlighted (block 319). At this time, the controller 100 can set priorities of the selected items. The priorities can be set according to the order selected by the user or a screen for setting priorities can be outputted so that the user can specify the priorities.

The controller 100 can allocate items selected by the user as the setting value of a shortcut key. Also, in the embodiment of the present invention, if sub-items of a specific menu are displayed in the process of adding the setting value of a specific menu that is previously set in a shortcut key, sub-items that are allocated as the setting value can be highlighted. Also, the controller 100 can exclude the items selected by the user for removal among items allocated as the setting value from the setting value.

The controller 100 can determine whether allocation of the setting value of the shortcut key is completed (block 323). At this time, if the setting of the shortcut key is completed, the controller 100 terminates execution of the shortcut key setting mode. Further, if the setting of the shortcut key is not completed, the controller 100 returns to step 317 and can execute the process of allocating a sub-item selected according to an input signal that selects at least one of the items among sub-items of a specific menu.

Also, in the embodiment of the present invention, the controller 100 can set priorities for applying the setting value allocated to the shortcut key by the user's change.

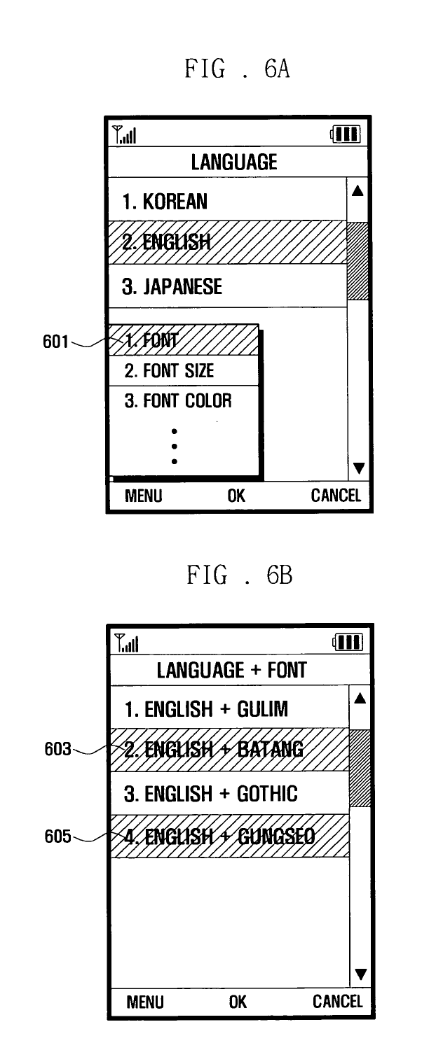

FIG. 5 illustrates a method of setting a shortcut key using combination mode of a portable terminal according to an exemplary embodiment of the present invention, and FIGS. 6A and 6B illustrate a method of setting a shortcut key using combination mode of a portable terminal according to an exemplary embodiment of the present invention.

Referring to FIGS. 5 to 6B, the controller 100 displays a screen of combination mode according to a combination mode execution signal (block 501). At this time, the controller 100 can allocate items selected among the list of items that can be combined among sub-items of a specific menu first selected in combination mode and sub-items of another menu selected by the user.

If combination mode is executed, the controller 100 can sense a signal that selects at least one of sub-items of a specific menu selected by the user (block 503). If a signal which selects at least one of sub-items of a specific menu is sensed, the controller 100 can store the selected item in the storage unit 130 (block 505). Further, if a signal that selects at least one of sub-items of a specific menu is not sensed, the controller 100 continually executes the process of selecting items. That is, if a signal that selects at least one of sub-items of a specific menu is not sensed, the controller 100 may maintain step 503.

Then, the controller 100 displays a list of menus that can be combined (block 507). At this time, the controller 100 can have stored items that can be generated through combinations as illustrated in Tables 1, 2 and 3.

If the menu list is displayed, the controller 100 determines whether a specific menu is selected (block 509). If a specific menu is not selected, the controller 100 can return to step 507. If a specific menu is selected, the controller 100 can control to display menu items which can be combined with a specific menu. For example, as illustrated in FIG. 6A, the controller 100 can present a menu such as a font 601, font size and font color as a menu that can be combined with a selected specific menu (language), and can sense the input of the font 601 which is selected among the menus. If the font 601 is selected, the controller 100 can display the list of items which can be combined with the selected specific menu on the screen (block 511).

If the list of items which can be combined is displayed on the screen, the controller 100 determines whether a selection signal for a specific item is sensed (block 513). At this time, if a specific item is selected, the controller 100 can highlight the item selected (block 515). For example, as illustrated in FIG. 6B, the controller 100 can highlight “2. English+Batang” 603 and “4. English+Gungseo” 605 selected on the screen where items that can be combined using English and Font such as “1. English+Gulim”, “2. English+Batang” 603, “3. English+Gothic”, and “4. English+Gungseo” 605 are presented. Further, if a selection signal of a specific item is not sensed, the controller 100 can return to step 511 and execute the process of displaying items that are combinable on the screen. Then, the controller 100 can allocate the selected item as the setting value of the shortcut key (block 517).

If a shortcut key is selected, the controller 100 determines whether a shortcut key setting completion signal is sensed (block 519). At this time, if the setting of the shortcut key is completed, the controller 100 can terminate execution of the shortcut key setting. Further, if the setting of the shortcut key is not completed, the controller 100 can return to step 503 and can execute the process of selecting items of a specific menu in order to allocate items for another combination mode to the shortcut key.

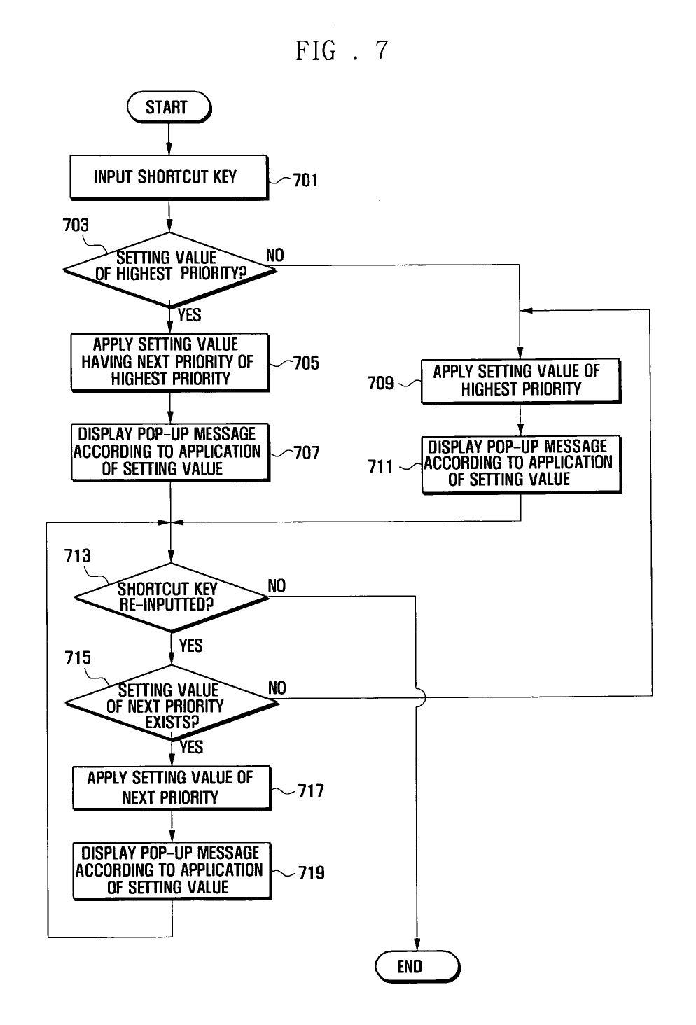

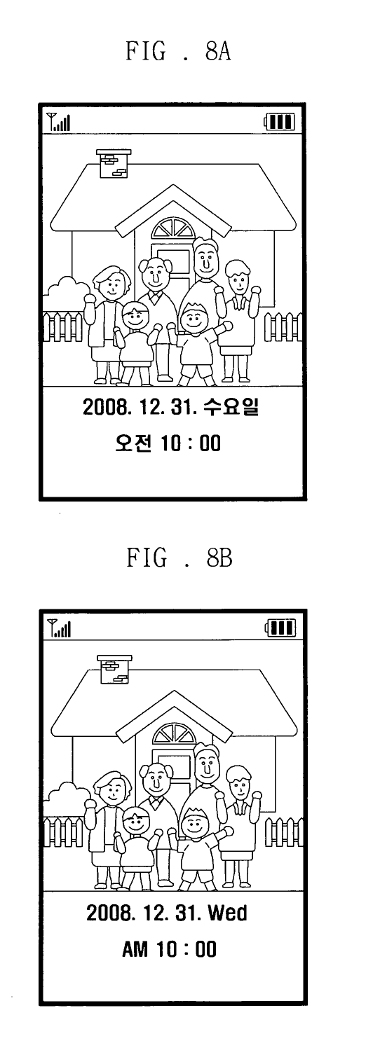

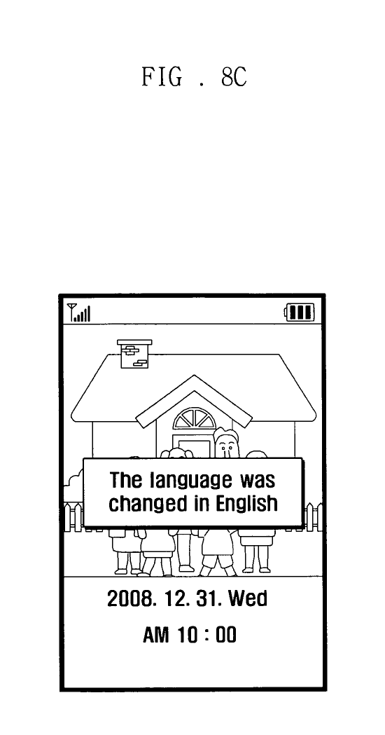

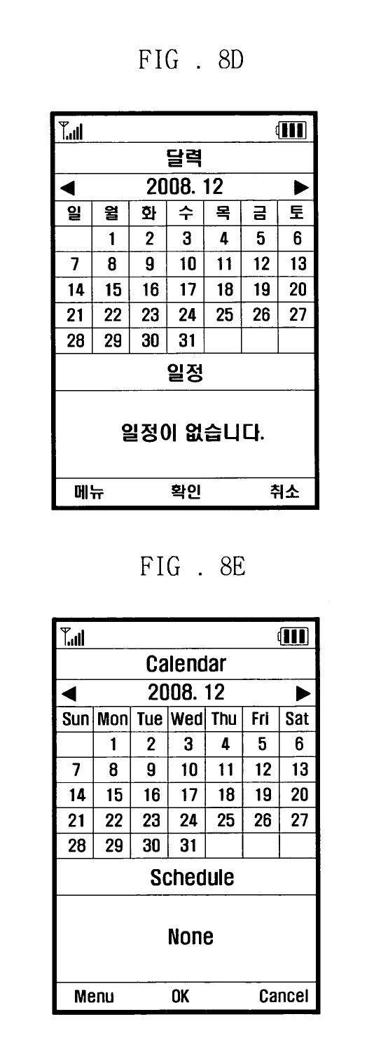

FIG. 7 illustrates a method of executing a menu using a shortcut key of a portable terminal according to an exemplary embodiment of the present invention, and FIGS. 8A to 8E illustrate a method of executing a menu using a shortcut key of a portable terminal according to an exemplary embodiment of the present invention.

Referring to FIGS. 7 to 8E, the controller 100 can sense a shortcut key input signal from the user (block 701). At this time, the controller 100 can be a specific key which is set by the user. Here, the controller 100 can determine an input signal of a specific key which is inputted more than a given time as a shortcut key signal.

If a shortcut key signal is inputted, the controller 100 determines whether the current setting value of the shortcut key is applied as the setting value of the highest priority (block 703). At this time, if applied as the setting value of the highest priority, the controller 100 applies the next setting value of the highest priority which is set in the shortcut key (block 705). For example, if Korean and English are allocated as the setting value in the idle screen displayed in Korea and a shortcut key signal where Korean has been set as the setting value of the highest priority is inputted, the controller 100 can change the language of the idle screen to English. That is, as illustrated in FIGS. 8A and 8B, the controller 100 can control to change the language of an idle screen from Korean to English.

Thereafter, the controller 100 can display a pop-up message according to the application of the setting value (block 707). For example, as illustrated in FIG. 8C, if the setting value is changed by the input of the shortcut key, the controller 100 can display a message “The language was changed in English” in the form of a pop-up window.

Further, in case a setting value of the highest priority is not applied at step 703, the controller 100 applies the setting value of the highest priority (block 709). Thereafter, the controller 100 can display a pop-up message according to application of the setting value (block 711).

The controller 100 can sense a re-input signal of the shortcut key within a given time after a short key is inputted (block 713). At this time, if the re-input signal of the shortcut key is not sensed, the controller 100 terminates execution of a menu that uses a shortcut key. Further, if the re-input signal of the shortcut key is sensed, the controller 100 determines whether a setting value of the next priority allocated to the shortcut key exists (block 715). Thereafter, if a setting value of the next priority exists, the controller 100 applies the next setting value (block 717). For example, if English is applied as a current setting value among Korean (highest priority), English (second priority) and Japanese (third priority), the controller 100 can change the setting value to Japanese of the next priority according to the re-input signal of the shortcut key. Thereafter, the controller 100 can display a pop-up message according to application of the setting value (block 719).

Further, if a setting value of the next priority does not exist, the controller 100 can return to step 709 to apply the setting value of the highest priority. For example, if Japanese is the current setting value among Korean (highest priority), English (second priority) and Japanese (third priority), the controller 100 can change the setting value with Korean which has the highest priority according to the re-input of the shortcut key.

Further, the case of changing an idle screen was explained in the above, but the present invention is not limited to changing an idle screen. For example, the present invention can change a language of a menu that is being executed according to the shortcut key signal inputted during when a menu is executed. For example, as illustrated in FIG. 8D, the present invention can change the language of schedule management menu to English according to the input signal of a shortcut key which is inputted for more than a given time while the schedule management menu is executed. As illustrated in FIG. 8E, the controller 100 can change the language of schedule management menu to English.

Also, an example of languages was explained as the setting value allocated to a shortcut key, but the setting value allocated to the shortcut key may include theme, font, font size, font color, text position, alarm, or the like. For example, the present invention can allocate sub-items such as Gulim, Batang, Gungseo and Gothic corresponding to fonts as the setting value of the shortcut key. Also, the present invention can allocate sub-items of 9pt, 10pt, 11pt and 12pt as the setting value of the shortcut key. Also, the present invention can allocate sub-items such as black, red, yellow and blue corresponding to font size as the setting value of the shortcut key. Also, the present invention can allocate sub-items of upper position, middle position and lower position corresponding to the text position as the setting value of the shortcut key. Also, the present invention can allocate sub-items such as after thirty (30) minutes, after one (1) hour, 6 AM and 9 PM corresponding to the alarm as the setting value of the shortcut key.

According to the present invention, a user of a portable terminal can designate a specific key as a shortcut key and can change a specific menu of the shortcut key according to the user's intention. Also, it is possible to allocate a plurality of menus to the shortcut key and sequentially apply the setting values allocated to the shortcut key by the input of the shortcut key.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for executing a menu using a shortcut key of a portable terminal, the method comprising:
sensing an input of a shortcut key; and
applying a setting value of the shortcut key, if the input of the shortcut key is sensed.

2. The method of claim 1, wherein an item selected by a user among sub-items of a specific menu is set as the setting value of the shortcut key.

3. The method of claim 1, wherein the setting value is an item selected among sub-items of a specific menu and is applied according to the input of the shortcut key.

4. The method of claim 1, further comprising setting an item selected among sub-items of a specific menu as a setting value.

5. The method of claim 4, wherein, in setting an item, two or more sub-items which are included in a plurality of menus respectively are combined and set as a setting value.

6. The method of claim 5, wherein setting an item comprises:
storing a specific item selected among sub-items of a specific menu;
presenting a list of menu which can be combined with the specific menu;
combining a sub-item of a menu selected among the list of menu with the stored specific item; and
setting an item selected among the combined items as a setting value of the shortcut key.

7. A method of claim 1, wherein applying a setting value comprises:
checking whether a current setting value is a setting value of highest priority, if an input of the shortcut key is sensed; and
applying a setting value having a next priority of the highest priority, if the current setting value is the setting value of highest priority.

8. The method of claim 7, wherein applying a setting value further comprises applying the setting value of highest priority, if the current setting value is not the setting value of highest priority.

9. The method of claim 1, wherein sensing an input comprises sensing a re-input signal of the shortcut key, after the setting value of the shortcut key is applied.

10. The method of claim 9, further comprising:
determining whether a setting value of next priority of current setting value exists if the re-input signal is sensed; and
applying the setting value of next priority of current setting value, if the setting value of next priority exists.

11. The method of claim 10, wherein applying the setting value further comprises:
applying a setting value of highest priority if the setting value of next priority does not exist.

12. The method of claim 1, after applying a setting value, further comprising presenting a message according to a change of the setting value in the form of a pop-up window.

13. An apparatus for executing a menu of a portable terminal, the apparatus comprising:
an input unit configured to input a shortcut key; and
a controller configured to apply a setting value of the shortcut key, if an input of the shortcut key is sensed.

14. The apparatus of claim 13, wherein an item selected among sub-items of a specific menu by a user is set as the setting value of the shortcut key.

15. The apparatus of claim 13, wherein the setting value is an item selected among sub-items of a specific menu and is applied according to the input of the shortcut key.

16. The apparatus of claim 13, wherein the controller sets an item selected among sub-items of a specific menu as a setting value of the shortcut key.

17. The apparatus of claim 13, wherein the controller executes a combination mode in which two or more sub-items which are included in a plurality of menus respectively are combined and set as a setting value.

18. The apparatus of claim 17, wherein the controller stores a specific item selected among sub-items of a specific menu, combines the stored specific item with a sub-item of a menu selected among a list of the menus that can be combined with the specific menu, and sets an item selected among the combined items as a setting value of the shortcut key.

19. The apparatus of claim 13, wherein the controller checks whether a current setting value is a setting value of highest priority if an input of the shortcut key is sensed, and applies a setting value having a next priority of the highest priority if the current setting value is the setting value of highest priority.

20. The apparatus of claim 19, wherein the controller applies the setting value of highest priority, if the current setting value is not the setting value of highest priority.

21. The apparatus of claim 13, wherein the controller senses a re-input signal of the shortcut key, after the setting value of the shortcut key is applied.

22. The apparatus of claim 21, wherein the controller determines whether a setting value of next priority of current setting value exists if the re-input signal is sensed, and applies the setting value of next priority of current setting value if the setting value of next priority exists.

23. The apparatus of claim 21, wherein the controller applies a setting value of highest priority if the setting value of next priority does not exist.

24. The apparatus of claim 13, wherein the controller presents a message according a change of the setting value in the form of a pop-up window.

25. A mobile terminal, the mobile terminal comprising:
a display configured to display a menu;
an input unit configured to receive an input for a shortcut key; and
a controller configured to apply a setting value of the shortcut key, if an input of the shortcut key is sensed.
